(19) United States
(12) Patent Application Publication
(10) Pub. No.: US 2026/0277139 A1
(43) Pub. Date: Sep. 17, 2026

(54) ELECTROPHOTOGRAPHIC BELT AND ELECTROPHOTOGRAPHIC IMAGE-FORMING DEVICE

(71) Applicant: CANON KABUSHIKI KAISHA, Tokyo (JP)

(72) Inventors: MASAYUKI ONUMA, Chiba (JP); MEGUMI UCHINO, Tokyo (JP); KOJI SATO, Ibaraki (JP)

(21) Appl. No.: 19/668,617

(22) Filed: May 5, 2026

Related U.S. Application Data
(63) Continuation of application No. PCT/JP2024/039437, filed on Nov. 6, 2024.

(30) Foreign Application Priority Data
Nov. 8, 2023 (JP) 2023-191087

(51) Int. Cl. G03G 15/16; G03G 15/01

(52) U.S. Cl. CPC G03G 15/162; G03G 15/0189; G03G 2215/1623

(57) ABSTRACT

An electrophotographic belt capable of achieving both suppression of a decrease in electrical resistance and suppression of molding defects. The electrophotographic belt has at least a base layer, the base layer includes polyether ether ketone and carbon black, a content of the carbon black, based on a mass of the base layer, is 19.0 to 30.0 mass %, the carbon black includes a first carbon black having a thermal decomposition temperature of less than 700° C. and a second carbon black having a thermal decomposition temperature of at least 700° C., a water content of the base layer, which is calculated by heating a sample cut out from the base layer under a nitrogen atmosphere under specific conditions, is at least 0.60 mass %, and a crystallization temperature on cooling measured in differential scanning calorimetry of the base layer is at least 295.0° C.

### CROSS-REFERENCE TO RELATED APPLICATIONS

This application is a Continuation of International Patent Application No. PCT/JP2024/039437, filed Nov. 6, 2024, which claims the benefit of Japanese Patent Application No. 2023-191087, filed Nov. 8, 2023, both of which are hereby incorporated by reference herein in their entirety.

### BACKGROUND

### Field of the Technology

The present disclosure relates to an electrophotographic belt and an electrophotographic image forming apparatus equipped with the electrophotographic belt.

### Description of the Related Art

In an electrophotographic image forming apparatus, as a method for transferring a toner image to a transfer material, there is an intermediate transfer method in which a toner image formed on a photosensitive member is primarily transferred onto an intermediate transfer belt in the form of a belt, and then the toner image is secondarily transferred onto a transfer material.

In order to accurately and electrostatically transfer the toner image on the surface of the photosensitive member onto a transfer material, the electrophotographic belt used for the intermediate transfer belt preferably has small variation in the volume resistivity depending on the position of the electrophotographic belt, in addition to having the volume resistivity of the semiconductive region. Therefore, it is required that the plane in which the image is to be formed is substantially uniform. As electrical resistance values of the intermediate transfer belt, for example, those adjusted such that a volume resistivity is within a range of 1×10⁸ to 1×10¹³ Ω·cm and a surface resistivity is within a range of 1×10⁹ to 1×10¹⁵Ω/□ are widely used. As the target range of the electrical resistance value, an optimum range is selected in accordance with the configuration of the transfer portion of an image forming apparatus, in which the intermediate transfer belt is used, and the charging characteristics of the toner particle.

Japanese Patent Application Publication No. H06-254941 discloses a belt obtained by extruding polyether ether ketone (PEEK) containing a conductive filler into a tubular film, and then cutting the tubular film in an axial direction and in a direction perpendicular to the axial direction. It is also disclosed that the volume electrical resistance value of each portion of the belt is 10⁸ to 10¹⁷ Ω·cm.

However, when an electrophotographic belt exhibiting conductivity with the use of an electroconductive filler is used for forming electrophotographic images for a long period of time, for example, as an intermediate transfer belt, the electrical resistance of the electrophotographic belt is lowered in some cases. It is considered that such a decrease in electrical resistance occurs due to the following mechanism. This is a mechanism in which the intermediate transfer belt undergoes partial dielectric breakdown of a polyether ether ketone resin due to a repeated long period of time of the transfer electric field in the primary transfer and the secondary transfer so as to form a conductive path inside, thereby reducing the volume resistance of the intermediate transfer belt. It is considered that partial dielectric breakdown of the resin occurs when an electric field concentrates in the vicinity of carbon black aggregates in the polyether ether ketone resin and in minute gaps between large-size aggregates. Therefore, it is considered that the evaluation of the dispersibility of carbon black, which is a direct cause of dielectric breakdown, is effective for the evaluation of the temporal stability of electrical resistance.

In other words, a discharge occurs at the segment where the intermediate transfer belt is separated from the primary transfer roller and the secondary transfer roller, and an excessive current once flows inside the intermediate transfer belt. At this time, a high voltage is applied between carbon blacks which are conductive points, whereby the binder resin interposed between the carbon black particles is heated and carbonized. As a result, conduction is established between particles of carbon black that were originally electrically insulating, and conductivity increases. Japanese Patent Laid-Open No. 2012-177811 discloses that the above-mentioned decrease in electrical resistance can be solved by improving the dispersibility of carbon black in a binder resin. For this purpose, Japanese Patent Laid-Open No. 2012-177811 discloses melt-kneading carbon black and PEEK repeatedly (2 to 6 times).

### SUMMARY

However, the repetition of melt-kneading of the binder resin and carbon black disclosed in Japanese Patent Laid-Open No. 2012-177811 can be a factor in increasing the manufacturing cost of the electrophotographic belt. Further, the repetition of kneading at high temperature may cause thermal degradation (crosslinking by thermal decomposition or oxidation) of the binder resin, raising a concern that the strength of the electrophotographic belt may be reduced. Furthermore, even when the dispersibility of carbon blacks is highly improved, it is difficult to make the inter-particle distances of all carbon blacks equal. Therefore, when an excessive current flows through the intermediate transfer belt, a high voltage is applied between the carbon black particles relatively close to each other. Therefore, it is difficult to completely prevent carbonization of the binder resin interposed between the carbon black particles. Accordingly, the inventors of the present invention recognized that it is necessary to develop a technique for suppressing the change (improvement) in conductivity due to carbonization of a binder resin by a method other than improving the dispersibility of carbon black.

Furthermore, in an electrophotographic belt containing carbon black, it was found that during belt molding, the thickness of the belt becomes unstable, resulting in molding defects in some cases.

At least one aspect of the present disclosure is directed to an electrophotographic belt capable of both suppressing a decrease in electrical resistance and suppressing molding defects. Further, at least one aspect of the present disclosure is directed to an image forming apparatus including the electrophotographic belt as an intermediate transfer belt.

According to at least one aspect of the present disclosure, an electrophotographic belt, including at least a base layer, wherein the base layer includes polyether ether ketone and carbon black, a content of the carbon black, based on a mass of the base layer, is 19.0 to 30.0 mass %, the carbon black includes a first carbon black having a thermal decomposition temperature of less than 700° C. and a second carbon black having a thermal decomposition temperature of at least 700° C., in a case where, when a sample cut out from the base layer is heated from 30° C. to 100° C. at a rate of 20° C./min under a nitrogen atmosphere and held at 100° C. for 30 minutes, a mass of the sample is defined as X1, and thereafter, when the sample is cooled from 100° C. to 30° C. at a rate of 20° C./min and further left for 48 hours in an environment at a temperature of 23° C. and a relative humidity of 50% under the atmosphere, a mass of the sample is defined as X2, a water content of the base layer, which is calculated by water content of base layer=((X2-X1)/X2)×100, is at least 0.60 mass %, and a crystallization temperature on cooling measured in differential scanning calorimetry of the base layer is at least 295.0° C. is provided.

In addition, according to at least one aspect of the present disclosure, an electrophotographic image forming apparatus including the above electrophotographic belt is provided.

Features of the present disclosure will become apparent from the following description of embodiments with reference to the attached drawings.

### BRIEF DESCRIPTION OF THE DRAWINGS

FIG. 1 is a schematic view of a cross-section of an image forming apparatus using an electrophotographic belt according to the present disclosure.

FIG. 2 is a schematic view of thickness measurement locations of the electrophotographic belt according to the present disclosure.

### DESCRIPTION OF THE EMBODIMENTS

In the present disclosure, the description “from XX to YY” or “XX to YY” representing a numerical range means a numerical range including a lower limit and an upper limit, which are endpoints, unless otherwise specified. In a case where numerical ranges are described stepwise, an upper limit and a lower limit of each numerical range can be arbitrarily combined. In the present disclosure, for example, a description such as “at least one selected from the group consisting of XX, YY and ZZ” means any of XX, YY, ZZ, XX and YY in combination, XX and ZZ in combination, YY and ZZ in combination, and XX, YY and ZZ in combination. Also, “Ω/□” in the present disclosure means “Ω/square”.

Hereinafter, an electrophotographic belt, an electrophotographic belt manufacturing method, and an electrophotographic image forming apparatus (hereinafter also referred to as an “image forming apparatus”) according to the present disclosure will be described.

### Electrophotographic Belt

The electrophotographic belt is, for example, an intermediate transfer belt. The electrophotographic belt includes at least a base layer (base material), and may further be a laminate configured of a plurality of layers including a surface layer (outer layer). As described below, the base layer includes a polyether ether ketone and carbon black. The base layer is a semiconductive film containing, for example, carbon black as conductive filler.

A sample cut out from the base layer is heated under a nitrogen atmosphere from 30° C. to 100° C. at a rate of 20° C./min and held at 100° C. for 30 minutes, and the mass of the sample is defined as X1. Thereafter, the sample is cooled from 100° C. to 30° C. at a rate of 20° C./min, and the mass of the sample when the sample is further left for 48 hours in an environment at a temperature of 23° C. and a relative humidity of 50% under the atmosphere is defined as X2.

A value (water content), calculated by water content of base layer=((X2−X1)/X2)×100, is 0.60 mass % or more.

Here, X1 is a mass of the sample cut out from the base layer when the sample is heated from a temperature of 30° C. to a temperature of 100° C. at a rate of 20° C. per minute under a nitrogen atmosphere and held at a temperature of 100° C. for 30 minutes. The X1 is positioned as a mass in a state where water in the sample was removed (hereinafter also referred to as a “dry state”).

Further, X2 is a mass of the sample obtained by cooling the sample in the dry state from a temperature of 100° C. to a temperature of 30° C. at a rate of 20° C. per minute and then leaving the sample for 48 hours in an environment at a temperature of 23° C. and a relative humidity of 50% under the atmosphere. The X2 is positioned as a mass in a state where the sample, once brought into the dry state, absorbed water (hereinafter also referred to as a “water-absorbed state”).

Thus, the value calculated by ((X2−X1)/X2)×100 is referred to in the present disclosure as “water content of base layer”. Accordingly, the present inventors found that an electrophotographic belt provided with a base layer having a water content of 0.60 mass % or more is difficult to change in conductivity even by repeated use for a long period of time.

As described above, it is considered that the increase in conductivity over time in the conventional electrophotographic belt including a base layer containing PEEK as a binder resin and carbon black as conductive particles dispersed in the binder resin is caused by carbonization of the binder resin interposed between carbon black particles due to application of a high voltage between carbon blacks.

On the other hand, the base layer according to the present disclosure, in which the water content of the base layer measured by the above-described method is 0.60 mass % or more, stably contains a certain amount of moisture in a normal office environment at a temperature of 23° C. and a relative humidity of 50% under the atmosphere. The base layer that stably contains moisture consumes the energy by evaporation or electrolysis of the moisture, even when a high voltage is applied between the carbon black particles due to the above-described discharge phenomenon. Therefore, carbonization of the binder resin present between the carbon black particles is suppressed, and it is considered that insulation between the carbon black particles is better maintained. As a result, it is considered that the conductivity of the base layer becomes difficult to change (increase) even through repeated use for a long period of time.

As described above, the base layer, even after once being brought into the dry state, can again contain a certain amount of water by being left for 48 hours in an environment at a temperature of 23° C. and a relative humidity of 50% under the atmosphere. Accordingly, in the electrophotographic belt according to the present disclosure, even when moisture in the base layer evaporates or decomposes due to application of a high voltage and is consumed once, the base layer can again absorb moisture. Therefore, carbonization of PEEK can be continuously suppressed even when used for a long period of time. As a result, it is considered that a change in conductivity can be suppressed even through use for a long period of time.

The glass transition point of PEEK contained in the base layer is, for example, about 143° C. Since the heat absorbing effect due to moisture appears at a temperature sufficiently lower than the glass transition point of the PEEK, it is also expected that the electrical resistance change due to the influence of the shrinkage of the resin due to heat generation can be suppressed.

Thus, the inventors of the present invention prepared an endless type electrophotographic belt by melt-extruding, from a cylindrical die, a resin composition in which carbon black was dispersed in a polyether ether ketone such that the water content of the base layer was within the above-mentioned numerical range.

However, the film thickness of the obtained electrophotographic belt varies. Accordingly, the present inventors recognized that, in order to obtain an electrophotographic belt in which the water content of the base layer is within the above-mentioned numerical values and in which the conductivity is difficult to change even through use for a long period of time, it is necessary to improve the thickness unevenness.

Here, the present inventors presume the reason why unevenness in the film thickness occurs when the water content of the base layer, which is a cylindrical extrusion molded product of a polyether ether ketone containing carbon black, is 0.60 mass % or more is as follows. That is, the thickness of a cylindrical base layer molded by a cylindrical extrusion molding method is adjusted as the resin composition to be molded into the base layer is extruded from the cylindrical die in the molten state and drawn downwards.

However, when the crystallization temperature on cooling of the base layer is low, the resin material extruded from a cylindrical die is taken up without being sufficiently crystallized, and thus the force is not transmitted in a take-up direction and the thickness becomes thin. As the thickness becomes thinner, the material accumulates at the exit of the cylindrical die, but is extruded from the rear, and thus the thickness becomes thicker because the material is extruded at a stretch at a certain timing. It is considered that this repetition caused the thickness unevenness.

The present inventors checked that the crystallization temperature on cooling of the base layer having a water content of 0.60 mass % or more was lower than that of the crystallization temperature on cooling of the base layer having a water content of less than 0.60 mass %. This is because, as one factor contributing to a high water content, a large number of surface functional groups of the carbon black contained in the base layer can be cited. However, on the other hand, since the surface functional groups inhibit crystallization of the polyether ether ketone, it is considered that the crystallization temperature on cooling decreases.

According to studies made by the present inventors, it was found that thickness unevenness is particularly likely to occur when a crystallization temperature on cooling of the base layer is lower than 295.0° C. Accordingly, the present inventors recognized that, in order to obtain an electrophotographic belt that achieves both stable conductivity and thickness uniformity at a high level, it is important to set the crystallization temperature on cooling, as measured by differential scanning calorimetry of a base layer having a water content within the above-mentioned numerical range, to 295.0° C. or higher.

When the crystallization temperature on cooling of the base layer is 295.0° C. or higher, crystallization is more likely to proceed during the above-described extrusion molding, a phenomenon in which the thickness becomes thin due to take-up is suppressed, and thus, it is considered that the thickness unevenness can be suppressed. Accordingly, by setting the crystallization temperature on cooling of a base layer having a water content of 0.60 mass % or more to 295.0° C. or higher, it is possible to achieve both suppression of a decrease in electrical resistance and suppression of molding defects.

In addition, the water content of the base layer is preferably 0.60 to 0.90 mass %, and more preferably 0.60 to 0.85 mass %.

The crystallization temperature on cooling of the base layer can be controlled by controlling the type and content of the second carbon black to be described later. The crystallization temperature on cooling of the base layer needs to be 295.0° C. or higher, is preferably 295.0 to 340.0° C., more preferably 296.0 to 320.0° C., and still more preferably 297.0 to 310.0° C.

### Method for Measuring Water Content

The water content of the base layer is calculated by measuring the change in mass using a thermogravimetry apparatus under the following conditions. A plurality of samples cut out from the base layer of the electrophotographic belt into dimensions of 4 mm×4 mm were stacked in a 100 μL platinum sample pan such that a total mass became 15 mg±4 mg.

Then, a mass of the sample when the sample was heated from a temperature of 30° C. to a temperature of 100° C. at a rate of 20° C./min under a nitrogen atmosphere and held at a temperature of 100° C. for 30 minutes was defined as X1. Thereafter, the sample was cooled from a temperature of 100° C. to a temperature of 30° C. at a rate of 20° C./min, and the mass of the sample when the sample was further left for 48 hours in an environment at a temperature of 23° C. and a relative humidity of 50% under the atmosphere was defined as X2. At this time, a mass change rate calculated by the following Formula (1) was defined as a water content of the base layer.

In the electrophotographic belt according to the present disclosure, the water content of the base layer is 0.60 mass % or more. It should be noted that, when the same evaluation was performed on the binder resin alone containing no carbon black at all, the water content of the PEEK resin was less than 0.04 mass %.

$$Water content of base layer = ( ( X 2 - X 1 ) / X 2 ) \times 100. \qquad ( 1 )$$

### Method for Measuring Crystallization Temperature on Cooling

In a differential scanning calorimetry (DSC) apparatus, the peak temperature, which is detected in the process of lowering the temperature from the molten state, is defined as the crystallization temperature on cooling.

The crystallization temperature on cooling is measured by cutting a sample out from the base layer, setting the sample in a DSC, heating the sample to 400° C. at 10° C./min, and thereafter cooling the sample to room temperature (25° C.) at 10° C./min, and measuring a peak temperature that appears during the cooling.

### Resin Material

An electrophotographic belt is required to have strength such that the belt does not elongate even when continuously subjected to a tensile load over a long period of time in an electrophotographic image forming apparatus. Therefore, it is preferable that a thermoplastic resin material used as a binder resin of the base layer be one that is classified as a super engineering plastic. In addition, the base layer according to the present disclosure contains polyether ether ketone (PEEK). The base layer preferably contains PEEK as a binder resin, for example.

PEEK is commercially available in various grades. However, in the present disclosure, a single grade may be used, or two or more grades may be used in combination.

Examples of commercially available PEEK include the “Victrex PEEK” series, which is a product name of products manufactured by Victrex plc. Examples of grades include PEEK grades “450G”, “381G”, and “151G”.

The content of PEEK in the base layer is preferably 70.0 to 81.0 mass %, and more preferably 75.0 to 80.0 mass %.

### Carbon Black

The base layer according to the present disclosure contains carbon black as a conductivity-imparting agent.

The melting point of PEEK used as the binder resin is, for example, about 330° C. Therefore, when an endless type conductive base layer is manufactured by using these resins, it is difficult to use an ionic conductivity-imparting agent, and carbon black is used. In order to achieve the surface resistivity described above using carbon black, the content of the carbon black in the base layer is set to 19.0 to 30.0 mass % based on the mass of the base layer. The content of carbon black in the base layer is preferably 19.0 to 25.0 mass %. The content of carbon black here is the total content of the content of a first carbon black and the content of a second carbon black.

The content of carbon black in the base layer can be measured by the following procedures.

The content (mass %) of the carbon black can be calculated by measuring the density p of the base layer using a dry density meter. The carbon black content can be calculated from the measured density p, a density of carbon black of 1.6 g/cm³ of the carbon black, and a density of polyether ether ketone 1.3 g/cm³.

Further, the base layer contains the first carbon black and the second carbon black which will be described later.

### First Carbon Black

Carbon black (CB) includes the first carbon black having a thermal decomposition temperature of less than 700° C. The first carbon black is preferably a carbon black in which a water absorption rate of the carbon black described hereinafter (hereinafter also referred to as a CB water absorption rate) of 0.70 mass % or more. The use of such a carbon black makes it easier to control the water content of the base layer to 0.60 mass % or more. From a viewpoint of a CB water absorption rate, furnace black is preferable for the first carbon black.

Further, a water absorption rate varies depending on a trace amount of functional groups on a surface and a structure. Carbon black having a water absorption rate of 0.70 mass % or more generally has a thermal decomposition temperature of less than 700° C. due to an influence of functional groups. The thermal decomposition temperature of the first carbon black is preferably 680° C. or lower. The thermal decomposition temperature of the first carbon black is preferably, for example, 650° C. or higher and less than 700° C., and more preferably 650° C. to 680° C.

The content of the first carbon black based on a mass of the base layer is preferably 18.0 mass % or more. When the content of the first carbon black is within this range, even when used for a long period of time, a water content sufficient to suppress carbonization of the PEEK can be obtained. The content of the first carbon black, based on the mass of the base layer, is preferably 18.0 to 25.0 mass %, and more preferably 18.3 to 24.5 mass %.

Further, a number-average particle diameter of primary particles of the first carbon black is preferably 15 nm or more and less than 35 nm, and more preferably 20 to 30 nm. When the number-average particle diameter is within the above range, the carbon black can be more easily uniformly dispersed in the PEEK.

As the first carbon black, “#3230B” (trade name, manufactured by Mitsubishi Chemical Corporation) can be suitably used from a viewpoint of water content and water absorption rate. In addition to “#3230B”, examples of commercially available carbon black having a CB water absorption rate of 0.70 mass % or more include, for example, “#44B” (trade name, manufactured by Mitsubishi Chemical Corporation; water absorption rate=0.95%). It should be noted that carbon black that can be used is not limited to these examples.

### Method for Measuring Water Absorption Rate

The mass after leaving the carbon black for 48 hours under conditions of a temperature of 23° C. and a relative humidity of 50% was measured using a thermogravimetric analyzer (TGA), and is defined as W0. A mass of the carbon black for which W0 was measured, when the carbon black is heated from 30° C. to 120° C. at 20° C./min under a nitrogen atmosphere and held at a temperature of 120° C. for 15 minutes, is similarly measured using a thermogravimetric analyzer (TGA), and is defined as W1.

$$CB water absorption rate = [ ( W 0 - W 1 ) / W 0 ] \times 100 \qquad ( 2 )$$

A CB water absorption rate of the first carbon black is more preferably 0.90 to 2.00 mass %, and still more preferably 0.95 to 1.50 mass %.

### Method for Measuring Thermal Decomposition Temperature of Carbon Black

In a thermogravimetric-differential thermal analysis apparatus (TG-DTA), an exothermic peak detected during a heating process under an oxygen atmosphere is defined as a thermal decomposition temperature of carbon black. A thermal decomposition temperature of carbon black is measured by cutting a sample of the base layer out from the electrophotographic belt, setting the sample in a TG-DTA, heating the sample from 30° C. to 800° C. under a nitrogen atmosphere, and then cooling the sample to 400° C. Thereafter, an exothermic peak temperature during heating to 800° C. under an oxygen atmosphere is measured. The heating is performed at a rate of 10° C./min. As the TG-DTA, a TG-DTA6300 manufactured by Hitachi High-Tech Corporation can be used.

It should be noted that, when calculating a thermal decomposition temperature of the first carbon black and a thermal decomposition temperature of the second carbon black in the base layer, a lower one of the decomposition temperatures is taken as the thermal decomposition temperature of the first carbon black. This is because the first carbon black having a large water content has a large number of surface functional groups, and decomposition starts from a lower temperature due to an influence of the functional groups.

Further, the carbon black may be subjected, for example, to a treatment for forming fine protruded portions derived from an organic compound on a surface by applying a treatment described below to commercially available carbon black. In the present specification, carbon black prior to the treatment may be referred to as “raw material carbon black”. In addition, the carbon black having fine protruded portions on the surface after the treatment may be referred to as “treated carbon black” or simply “carbon black”.

### Method for Surface Treatment of Carbon Black

A surface treatment method for forming fine protruded portions on the surface of the raw material carbon black to obtain a treated carbon black will be described. A treatment for forming fine protruded portions on a surface of a raw material carbon black includes a first step of attaching an organic substance to the surface of the raw material carbon black, and a second step of firing the attached organic substance.

This surface treatment makes it easy to increase the water absorption rate of the carbon black.

First, a first step of attaching an organic substance to the surface of the raw material carbon black will be described.

The step of attaching an organic substance to the surface of the raw material carbon black may be performed by mixing the raw material carbon black with the organic substance while the raw material carbon black is maintained in a solid powder state. From a viewpoint of uniformly attaching the organic substance to the surface, it is preferable to mix the raw material carbon black with the organic substance in a liquid. Here, the step of attaching an organic substance to the surface of the raw material carbon black in a liquid will be described.

The first step is a step of dissolving an organic substance in a solvent to obtain an organic substance solution, and then adding and stirring the raw material carbon black in the organic substance solution to obtain a raw material carbon black dispersion.

A solvent that can be used includes water or an organic solvent. However, water is preferable in consideration of ease of handling and environmental impact. In order to improve the dispersed state of the raw material carbon black, a general dispersing agent may be used.

The organic substance to be attached to the raw material carbon black preferably has high affinity for a surface of the raw material carbon black and also high affinity for the solvent. Specifically, examples include organic compounds referred to as cationic surfactants, anionic surfactants, and nonionic surfactants. Among these, a nonionic surfactant is preferable because it is less likely to cause coarsening due to aggregation even when carbon black to which the organic substance is attached is taken out in a subsequent step.

Examples of the nonionic surfactant include ester-type and ether-type surfactants. Examples of the ester-type surfactant include glycerin fatty acid esters, sorbitan fatty acid esters, and sucrose fatty acid esters, each having a structure in which glycerin, sorbitan, or sucrose, which is a polyhydric alcohol, is ester-bonded with a fatty acid. Examples of the ether-type surfactant mainly include polyoxyethylene alkyl ethers, polyoxyethylene alkylaryl ethers, and polyoxyethylene propylene glycol, which are obtained by addition polymerization of ethylene oxide with higher alcohols, alkylphenols, propylene glycol, or the like. Among these, a polyoxyethylene alkyl ether that has affinity for the solvent and also has good affinity for a surface of conductive carbon is preferable.

The dispersant used may be a single type, or a plurality of dispersants may be used in combination.

The amount of the organic substance to be added to and dissolved in the solvent is preferably adjusted such that the amount is at or below a saturated solubility with respect to 100 parts by mass of the solvent, and such that, when the part by mass of the raw material carbon black is defined as A and the part by mass of the organic substance is defined as B with respect to 100 parts by mass of the solvent, a mass ratio “A/B” is from 0.1 to 20.0. More preferably, A/B is from 0.5 to 3.0.

By setting the amount of the organic substance added to be at or below the saturated solubility, precipitation of the organic substance can be suppressed, and processing of the raw material carbon black can be performed more easily.

Further, by setting the mass ratio A/B of carbon black to the organic substance to be 0.1 or more, the amount of the organic substance relative to the carbon black becomes appropriate, thereby making it possible to suppress an amount of the organic substance that cannot be attached to the surface of the raw material carbon black and remains suspended. Further, by setting the mass ratio A/B to 20 or less, processing of the raw material carbon black can be performed more efficiently.

The dissolution of the organic substance in the solvent can be promoted by appropriately selecting means for promoting dissolution of the organic substance, such as stirring with a stirring blade, ultrasonic vibration, a homogenizer, or a heat treatment in combination. Further, since there is a concern about foaming at the time of stirring, a defoaming agent or the like may be suitably selected.

The amount of the raw material carbon black to be added to the organic substance solution is preferably from 1 part by mass to 50 parts by mass, and more preferably from 5 parts by mass to 30 parts by mass, with respect to 100 parts by mass of the solvent.

Addition of the raw material carbon black to the organic substance solution is preferably performed little by little. Diffusion of the raw material carbon black in the organic substance solution can be carried out by means such as, for example, screw stirring, shear flow (a homogenizer or a nanomizer), high-pressure liquid collision, or media dispersion (a ball mill or a bead mill).

Next, the second step of firing the organic substance attached to the surface of the raw material carbon black will be described.

The second step is a step of removing the solvent from the dispersion of the raw material carbon black obtained in the first step with the organic substance attached to the surface of the raw material carbon black, and firing the obtained solid content.

A known method can be used as a method for removing the solvent from the raw material carbon black dispersion and extracting a solid content. Examples thereof include heating drying, vacuum drying, centrifugation, vacuum filtration, and the like. Heat drying is suitable when considering the amount processed in one batch. Examples of the heating drying include static drying in which the dispersion is left standing under a heated atmosphere, agitated drying, airflow drying in which drying is promoted by exposing the raw material carbon black dispersion to a heated airflow, and spray drying in which the raw material carbon black dispersion is sprayed in a mist form under a heated atmosphere to promote drying. However, in consideration of throughput and solvent removal efficiency, spray drying is preferable.

As the method for firing the extracted solid content, known methods can be used. Although firing apparatuses include a direct heating method and an indirect heating method, an indirect heating method is preferable because, in the method in which an object is directly heated by a flame such as a burner, temperature control is difficult and there is a possibility that the object may be burned away. More specifically, there are an electric furnace, a hot blast circulating furnace, a high-frequency induction heating furnace and the like, and a hot blast circulating furnace excellent in the uniformity of the heating temperature is preferable. Further, heating furnaces include batch-type heating furnaces and continuous-type heating furnaces. However, although the continuous-type heating furnace has mechanisms for charging and discharging, it is not suitable for long-time heating, and therefore a batch-type heating furnace is preferable. At this time, in order to suppress excessive firing, the atmosphere in the heating furnace may be replaced with, for example, nitrogen.

The firing temperature is preferably equal to or higher than the thermal decomposition onset temperature of the organic substance and lower than the thermal decomposition temperature of the raw material carbon black. When the firing temperature is equal to or higher than the thermal decomposition onset temperature of the organic substance, the organic substance attached to the surface of the raw material carbon black is decomposed to form treated carbon black having a protruded shape on the surface. Further, by setting a firing temperature to be lower than a thermal decomposition temperature of the raw material carbon black, it is possible to suppress burning loss of the raw material carbon black during the treatment step. Specifically, a firing temperature is preferably, for example, from 300° C. to 600° C., and particularly preferably from 350° C. to 500° C.

Further, nitrogen treatment may be performed as the treatment of the carbon black. By nitrogen treatment, dispersing agents and the like to be attached to the carbon black during a manufacturing process can be removed. The nitrogen treatment can be, for example, a method in which carbon black to be treated is fired under a nitrogen atmosphere. A firing temperature is preferably, for example, from 300° C. to 600° C., and particularly preferably from 350° C. to 500° C. The firing time is, for example, 1 to 10 hours, preferably 2 to 8 hours.

### CB Water Content

Here, the amount of water contained in the carbon black (hereinafter also referred to as “CB water content”) can be measured and calculated by the following steps (iv) to (v), regardless of whether the above-mentioned surface treatment is performed or not.

Step (iv): A mass (W2) of carbon black to be evaluated after being left for 48 hours under conditions of a temperature of 23° C. and a relative humidity of 50% is measured using a TGA.

Step (v): A mass (W3) of the carbon black for which the mass (W2) was measured, when the carbon black is heated from 30° C. to 120° C. at a rate of 20° C. per minute under a nitrogen atmosphere and held at a temperature of 120° C. for 15 minutes, is measured using a TGA.

The CB water content (mass %) is calculated according to the following Calculation Formula (2).

$$CB water content = ( ( W 2 - W 3 ) / W 2 ) \times 100 \qquad ( 2 )$$

The CB water content of the first carbon black is preferably 1.00 to 4.00 mass %, more preferably 2.00 to 3.00 mass %, and still more preferably 2.30 to 2.80 mass %.

### Second Carbon Black

The carbon black includes the second carbon black having a thermal decomposition temperature of 700° C. or higher. The second carbon black is carbon black having a thermal decomposition temperature of 700° C. or higher as measured by TG-DTA, and acetylene black is preferable.

Carbon black having a thermal decomposition temperature of 700° C. or higher has fewer surface functional groups, and accordingly, interaction with PEEK molecules is more likely to occur and the carbon black is more likely to serve as crystal nuclei. Therefore, by adding the second carbon black, the crystallization temperature on cooling of the base layer can be easily raised to 295.0° C. or higher. Further, by adding the second carbon black in an amount of 0.3 mass % or more, it becomes easier to set a crystallization temperature on cooling of the base layer to 295.0° C. or higher. The content of the second carbon black based on a mass of the base layer is preferably 0.3 mass % or more, and more preferably 0.5 mass % or more. The content of the second carbon black based on a mass of the base layer is preferably 0.3 to 1.0 mass %, and more preferably 0.5 to 0.7 mass %.

The thermal decomposition temperature of the second carbon black is preferably 730° C. or higher. The thermal decomposition temperature of the second carbon black is preferably, for example, 700 to 790° C., and more preferably 730 to 780° C.

Further, a number-average particle diameter of primary particles of the second carbon black is preferably 15 nm or more and less than 50 nm, and more preferably 20 to 35 nm. When the number-average particle diameter is within the above range, the carbon black can be more easily uniformly dispersed in the PEEK.

Examples of the second carbon black include, from a viewpoint of thermal decomposition temperature, “Denka Black” (trade name, manufactured by Denka Company Limited) and “#4000B” (trade name, manufactured by Mitsubishi Chemical Corporation). Note that the carbon blacks that can be used are not limited to those described above.

The second carbon black may also be subjected to the surface treatment for forming fine protruded portions derived from an organic compound on the surface. Further, the above-described nitrogen treatment may also be performed on the second carbon black.

The CB water absorption rate of the second carbon black is preferably less than 0.70 mass %, more preferably 0.10 to 0.50 mass %, and even more preferably 0.15 to 0.30 mass %.

The CB water content of the second carbon black is preferably 0.05 mass % or more and less than 1.00 mass %, more preferably 0.10 to 0.50 mass %, and even more preferably 0.15 to 0.30 mass %.

### Method for Manufacturing Electrophotographic Belt

The method for manufacturing an electrophotographic belt such as the intermediate transfer belt is not particularly limited, and known methods can be employed. The electrophotographic belt may have a single layer or two or more layers. The base layer of an electrophotographic belt is manufactured, for example, through the following steps (1) and (2). The base layer is preferably a cylindrical extrusion molded product of a resin composition containing polyether ether ketone and carbon black.

(1) A mixing step of obtaining a resin composition by mixing a resin material containing polyether ether ketone (thermoplastic resin) and a conductive filler containing carbon black under a temperature environment in which the temperature of the resin material is equal to or higher than the glass transition point of the resin material.

(2) A molding step of melting the resin composition obtained in the mixing step at a temperature equal to or higher than a melting temperature of the resin material and molding the resin composition into a cylindrical tube shape.

Hereinafter, each step (1) and (2) will be described in detail.

### Mixing Step

In the mixing step, the thermoplastic resin and the conductive filler are mixed under an environment of a temperature equal to or higher than the glass transition point of the thermoplastic resin to obtain a resin composition. As a mixer used in the mixing step, for example, a twin screw mixer equipped with two screws in a barrel or cylinder can be used.

The mixture of materials fed from a feeding port of the feeding portion advances toward a die by rotation of a screw, and is shear-heated and melt-mixed by friction between a barrel or a cylinder, the screw, and the raw materials. It is preferable to perform cooling or temperature adjustment from outside a barrel or a cylinder, adjustment of a rotational speed of the screw, and the like, to control the raw materials such that a temperature thereof does not become excessively high.

From a viewpoint of improving a dispersion state of the conductive filler and obtaining a resin composition having excellent mechanical, electrical, and optical properties, a temperature during kneading is preferably, for example, 300 to 400° C., and more preferably 340 to 380° C. At a tip portion of a twin-screw kneader, a strand die is usually installed, and the resin composition is extruded into a rod shape, air-cooled, and then cut to prepare a pellet-shaped resin composition. The extrusion amount during kneading and a rotational speed of an apparatus may be appropriately set from a viewpoint of uniformly mixing the resin composition.

Note that before the mixing step, a premixing step may be provided in which the thermoplastic resin and the conductive filler are mixed by a fluidized mixer in a temperature environment lower than a glass transition temperature of the thermoplastic resin. As the fluidized mixer, various known mixers having a mechanism for mixing by utilizing fluid motion of solids can be used. However, specifically, mixers such as a Henschel mixer, a ribbon mixer, and a planetary mixer can be used.

Among them, the Henschel mixer is preferably used from a viewpoint of mixing efficiency. The rotational speed, processing time, processing amount, and the like of the fluidized mixer may be appropriately selected in accordance with the material.

### Molding Step

In the molding step, the resin composition obtained in the mixing step is molded into an electrophotographic belt. For example, the belt is molded into an electrophotographic belt in the shape of an endless belt such as a cylindrical tube. For molding, methods such as an extrusion molding method or an inflation molding method can be selected depending on the resin to be used. However, from a viewpoint of productivity, it is preferable to use a cylindrical extrusion molding method. The base layer is preferably an extrusion molded product.

As an extruder in the extrusion molding method, either a single-screw extruder provided with one screw in a barrel or a cylinder, or a multi-screw extruder in which two or more screws are combined, can be used. The pellet-shaped resin composition fed from the feeding port of the feeding portion advances toward the die by rotation of the screw, and, while receiving thermal energy from the barrel or the cylinder and mechanical energy from the screw, is substantially completely melted and quantitatively fed to a tip portion of the extruder. A cylindrical die is installed at a tip portion of the extruder, and by extruding downward from the cylindrical die and taking up the extrudate from below, the resin composition is molded into a cylindrical tube shape.

A temperature during extrusion molding (for example, a die temperature) is not particularly limited, but is preferably, for example, 300 to 400° C., and more preferably 340 to 380° C.

The conductivity of the base layer is not particularly limited, but, in consideration of primary transferability and secondary transferability when the base layer is used as an intermediate transfer belt, for example, a surface resistivity of the base layer is preferably in a range from 1.0×10³Ω/□ to 1.0×10¹⁴Ω/□. More preferably, the surface resistivity is in a range from 1.0×10⁵Ω/□ to 1.0×10¹³Ω/□, and still more preferably in a range from 1.0×10⁹Ω/□ to 1.0×10¹³Ω/□.

It should be noted that the thickness of the base layer (that is, the thickness of the electrophotographic belt) is not particularly limited. The thickness of the base layer is preferably 25 to 100 μm, and more preferably 40 to 80 μm.

The obtained base layer may be further subjected to a heating and cooling treatment. Mechanical strength of PEEK varies greatly depending on a degree of crystallinity thereof. Therefore, by performing a heating and cooling treatment in accordance with usage conditions, it is possible to adjust the degree of crystallinity and obtain an electrophotographic belt having desired mechanical strength.

Further, since the base layer obtained via the above-described steps is subjected to a heating step, there is a possibility that the water content is temporarily low immediately after the manufacturing. However, for example, by storing the base layer for 48 hours or longer in an environment at a temperature of 23° C. and a relative humidity of 50%, the water content of the base layer can be controlled within the above-described range.

The base layer obtained as described above may thereafter be provided with a surface layer covering the outer peripheral surface and a rear surface layer covering the inner peripheral surface, if necessary. Examples of the surface layer include a layer having excellent wear resistance, including a cured product of an active energy ray-curable resin, such as an acrylic resin. In this case, the surface layer can be provided, for example, by applying a composition containing an active energy ray-curable resin such as a photocurable resin onto the outer peripheral surface of the base layer and curing the applied composition.

The thickness of the surface layer is not particularly limited, but is preferably 1 to 5 μm, for example. Examples of the rear surface layer include, for example, a resin layer for reinforcing the base layer and a conductive layer for imparting conductivity to an inner peripheral surface of the electrophotographic belt. The thickness of the rear surface layer is not particularly limited, but, for example, is preferably 0.05 to 10 μm.

### Electrophotographic Image Forming Apparatus

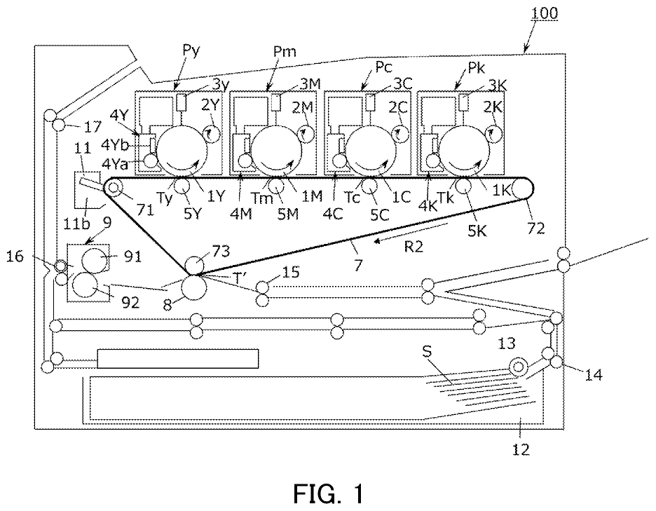

An electrophotographic image forming apparatus includes an electrophotographic belt. An embodiment of the image forming apparatus using the endless electrophotographic belt according to the present disclosure as the intermediate transfer belt will be described. FIG. 1 is a schematic cross-sectional view of the image forming apparatus 100 of the present embodiment. The image forming apparatus 100 of the embodiment is a tandem type color laser printer employing an intermediate transfer method, which can form a full color image by using an electrophotographic method.

The image forming apparatus 100 may include first, second, third, and fourth image forming portions Py, Pm, Pc, and Pk, each of which serves as a plurality of image forming portions. The first, second, third, and fourth image forming portions Py, Pm, Pc, and Pk are arranged in this order along the moving direction of a flat part (image transfer surface) of an intermediate transfer belt 7 described later. For elements having the same or corresponding functions or configurations in the first, second, third, and fourth image forming portions Py, Pm, Pc, and Pk, a description may be given collectively with the suffixes Y, M, C, and K, which indicate elements for respective colors, omitted. In the embodiment, the image forming section P includes a photosensitive drum 1, a charging roller 2, an exposure device 3, a developing device 4, and a primary transfer roller 5, which will be described later.

The image forming section P includes the photosensitive drum 1 which is a drum-shaped (cylindrical) photosensitive member (electrophotographic photosensitive member) as an image bearing member (first image bearing member) for bearing an unfixed toner image. The photosensitive drum 1 is formed, for example, by laminating a charge generation layer, a charge transfer layer and a surface protective layer in this order on a cylinder made of aluminum as a base.

The photosensitive drum 1 is driven to rotate in the arrow R1 direction (counterclockwise) in the drawing. The surface of the rotating photosensitive drum 1 is uniformly charged to a predetermined potential of a predetermined polarity (negative polarity in the embodiment) by the charging roller 2 which is a roller-shaped charging member as charging means. During a charging step, a predetermined charging bias (charging voltage) including a negative DC component is applied to the charging roller 2. The surface of the photosensitive drum 1 that was charged is scanned and exposed according to image information by the exposure device (laser scanner) 3 serving as exposure means, thereby forming an electrostatic image (electrostatic latent image) on the photosensitive drum 1.

The electrostatic image formed on the photosensitive drum 1 is developed (visualized) by a toner as a developer fed by the developing device 4 as developing means, and an unfixed toner image (developer image) is formed on the photosensitive drum 1. During the developing step, a predetermined developing bias (developing voltage) containing a DC component of negative polarity is applied to the developing roller 4a serving as a developer bearing member of the developing device 4.

In the embodiment, toner charged to the same polarity as a charging polarity of the photosensitive drum 1 (negative polarity in the embodiment) is attached to an exposed portion (image portion) on the photosensitive drum 1 at which an absolute value of potential has been reduced by being exposed after being uniformly charged.

The intermediate transfer belt 7 including an endless belt as the intermediate transfer belt is disposed to oppose the four photosensitive drums 1. The intermediate transfer belt 7 is stretched with a predetermined tension by being looped around a driver roller 71, a tension roller 72, and a secondary transfer opposing roller 73, which serve as a plurality of stretching rollers. The intermediate transfer belt 7 rotates (circulates) in the arrow R2 direction (clockwise) in the drawing while being in contact with the photosensitive drum 1, by rotationally driving the driver roller 71.

On the inner peripheral surface side of the intermediate transfer belt 7, the primary transfer roller 5, which is a roller-shaped primary transfer member as primary transfer means, is disposed corresponding to each photosensitive drum 1. The primary transfer roller 5 is pressed against the photosensitive drum 1 via the intermediate transfer belt 7 to form a primary transfer portion (primary transfer nip) T in which the photosensitive drum 1 and the intermediate transfer belt 7 are in contact with each other. The unfixed toner image formed on the photosensitive drum 1 as described above is primarily transferred onto the rotating intermediate transfer belt 7 at the primary transfer portion T by the action of the primary transfer roller 5.

In the primary transferring step, a primary transferring bias (primary transfer voltage), which is a DC voltage having a polarity (positive polarity in the embodiment) opposite to the normal charging polarity (charging polarity in the developing step) of the toner, is applied to the primary transfer roller 5. The primary transfer roller 5 is composed of a metal rotating shaft and an elastic layer formed on an outer peripheral surface of the rotating shaft, and one adjusted to a desired resistance value is often used. However, the primary transfer roller 5 may also be configured as a metal roller made of a material such as SUM (sulfur and sulfur composite free-cutting steel) or SUS (stainless steel) and having a straight shape in the thrust direction.

In such primary transfer, a transfer voltage of several kilovolts is usually applied in order to secure a sufficient transfer rate. However, at that time, discharge may occur in the vicinity of the transfer nip. Incidentally, this discharge is one factor of lowering the surface characteristics of the intermediate transfer member. When the primary transfer roller is formed of a metal roller, a transfer nip is narrower than a primary transfer roller having an elastic layer, and discharge tends to occur. Therefore, the effects of the electrophotographic belt according to the disclosure are more remarkably exhibited in an apparatus in which the primary transfer roller 5 is constituted by a metal roller.

On the outer peripheral surface side of the intermediate transfer belt 7, a secondary transfer roller 8 which is a roller-shaped secondary transfer member as secondary transfer means is disposed at a position opposed to the secondary transfer opposing roller 73. The secondary transfer roller 8 is pressed toward a secondary transfer opposing roller 73 via the intermediate transfer belt 7, and forms a secondary transfer portion (secondary transfer nip) T′, in which the intermediate transfer belt 7 and the secondary transfer roller 8 are in contact with each other.

In the secondary transfer portion T′, the toner image formed on the intermediate transfer belt 7 as described above is secondary-transferred onto a recording material (sheet, transfer material) S such as paper (sheet) nipped and conveyed between the intermediate transfer belt 7 and the secondary transfer roller 8 by the action of the secondary transfer roller 8. During the secondary transfer step, a secondary transfer bias (secondary transfer voltage), which is a DC voltage having a polarity opposite to the normal charge polarity of the toner, is applied to the secondary transfer roller 8. In secondary transfer, a transfer voltage of several kilovolts is usually applied in order to secure sufficient transfer efficiency.

Similarly, the above-described image forming operation is performed in each of the magenta (M), cyan (C), and black (K) units Pm, Pc, and Pk in accordance with movement of the intermediate transfer belt 7, thereby stacking toner images of four colors, yellow, magenta, cyan, and black, on the intermediate transfer belt 7.

The four-color toner layers are conveyed in accordance with movement of the intermediate transfer belt 7, and are collectively transferred onto a recording material S conveyed at a predetermined timing by the secondary transfer roller 8 serving as secondary transfer means at a secondary transfer portion T2. In such secondary transfer, a transfer voltage of several kilovolts is usually applied in order to secure a sufficient transfer rate. However, at that time, discharge may occur in the vicinity of the transfer nip. Incidentally, this discharge is one factor of lowering the electrical resistance value of the intermediate transfer belt.

The recording material S is fed to a conveyance path from a cassette 12 in which the recording material S is stored, by a pickup roller 13. The recording material S fed to the conveyance path is conveyed to the secondary transfer portion T′ by a conveyance roller pair 14 and a resist roller pair 15 with timing matched to the toner image on the intermediate transfer belt 7.

The recording material S onto which the toner image was transferred is conveyed to a fixing device 9 serving as fixing means. The fixing device 9 includes a pressure roller 91 and a heating roller 92. The fixing device 9 fixes (melts and adheres) the toner image onto the recording material S by heating and pressing the recording material S that bears the unfixed toner image. The recording material S on which the toner image was fixed is discharged (output) to the outside of the apparatus main body of the image forming apparatus 100 by a conveyance roller pair 16, a discharge roller pair 17, and the like.

Toner (primary transfer residual toner) that is not transferred to the intermediate transfer belt 7 in the primary transfer step and remains on the surface of the photosensitive drum 1 is collected simultaneously with development by the developing device 4 that also serves as photosensitive member cleaning means 4b.

Further, toner (secondary transfer residual toner) that is not transferred to the recording material S in the secondary transfer step and remains on the surface of the intermediate transfer belt 7 is removed from the surface of the intermediate transfer belt 7 and collected by a belt cleaning device 11 serving as intermediate transfer belt cleaning means. The belt cleaning device 11 is disposed, in the rotation direction of the intermediate transfer belt 7, downstream of the secondary transfer portion T′ and upstream of the most upstream primary transfer portion Ty (in the embodiment, at a position opposing the driver roller 71).

The belt cleaning device 11 scrapes off the secondary transfer residual toner from the surface of the rotating intermediate transfer belt 7 by a cleaning blade serving as a cleaning member that is disposed to be in contact with the surface of the intermediate transfer belt 7, and accommodates the scraped toner in a collection container 11b.

Thus, in the image forming operation, an electrical transfer process of a toner image from the photosensitive drum 1 to the intermediate transfer belt 7 and from the intermediate transfer belt 7 to the recording material S is repeatedly performed. Further, by repeatedly performing image formation on a large number of recording materials S, the electrical transfer process is further repeatedly performed.

By using the above-described electrophotographic belt as the intermediate transfer belt in the electrophotographic image forming apparatus, it becomes possible to repeatedly form high-quality electrophotographic images over a long period of time.

Examples of the electrophotographic belt according to the present aspect will be described below. Incidentally, all of the steps of forming the electrophotographic belt in the aspect were carried out using a common apparatus, but the aspect is not limited to the following Examples.

### EXAMPLES

Hereinafter, the present disclosure will be specifically described based on Examples. Unless otherwise specified, amounts in the Examples and Comparative Examples are on a mass basis.

As conductive fillers used for preparing the intermediate transfer belts according to Examples and Comparative Examples, commercially available carbon blacks shown in Table 1 below were prepared, and the carbon blacks were subjected to the above-described surface treatment or nitrogen treatment.

It should be noted that the nitrogen treatment was performed as follows. The carbon black to be treated was fired (heat-treated) under a nitrogen atmosphere at a temperature of 430° C. for 6 hours.

Further, the surface treatment was performed as follows.

To 100 parts by mass of water, 10 parts by mass of a nonionic surfactant (polyoxyethylene alkyl ether) (manufactured by Sanyo Chemical Industries, Ltd.; trade name: “NAROACTY”) was added and dissolved, and thereafter 15 parts by mass of a raw material carbon black (manufactured by Mitsubishi Chemical Corporation; trade name: “#3230B”) was added. At this time, when the part by mass of the raw material carbon black is defined as A and the part by mass of the surfactant is defined as B with respect to 100 parts by mass of water, a ratio “A/B” was 1.5.

The mixture was stirred using a bead mill (“Alphamill”, trade name, manufactured by Aimex Co., Ltd.) to obtain a raw material carbon black dispersion. This raw material carbon black dispersion was subjected to moisture removal using a spray dryer (“Spray Dryer L-8i”, trade name, manufactured by Yamato Scientific Co., Ltd.) to obtain a solid content. The obtained solid content was fired at a temperature of 400° C. for 5 hours using a high-temperature furnace (“Constant Temperature Drying Oven DR200”, trade name, manufactured by Yamato Scientific Co., Ltd.).

Each of the properties (number-average particle diameter of primary particles, CB thermal decomposition temperature, CB water content, and CB water absorption rate) of the treated carbon black is shown in Table 1.

Primary particle diameter: Carbon black usually exists in a state where a plurality of primary particles are three-dimensionally arranged like a bunch of grapes. The number-average particle diameter of primary particles (hereinafter referred to as “primary particle diameter”) means the number-average particle diameter of carbon black (primary particles) as a minimum unit which forms one pigment particle. The primary particle diameter of carbon black can be obtained by observing and measuring particle diameters of about 100 carbon black particles, which are the smallest units forming pigment particles, using a transmission type or a scanning type electron microscope, and calculating an arithmetic mean value thereof.

Carbon black is used as a sample, and a TEM image is acquired using a transmission electron microscope (Transmission Electron Microscopy: TEM) (trade name: H-7100FA, manufactured by Hitachi, Ltd.) under measurement conditions of a TE mode and an accelerating voltage of 100 kV. For analysis of the obtained TEM images, known image analysis software such as “WinROOF” (trade name, manufactured by Mitani Corporation) and “ImagePro” (trade name, manufactured by Nippon Roper K.K.) can be used. In the disclosure, “WinROOF” was used. Then, area-equivalent diameters of 50 primary particles of the carbon black were measured, and an average value thereof was defined as a number-average particle diameter of primary particles.

TABLE 1

| | | | | Primary | CB thermal | CB | CB water |
|---|---|---|---|---|---|---|---|
| | | | | particle | decomposition | water | absorption |
| Abbre- | Manu- | Product | Type of carbon | diameter | temperature | content | rate |
| viation | facturer | name | black treatment | nm | ° C. | mass % | mass % |
| CB-A | Mitsubishi | #3230B | Nitrogen treatment | 23 | 670 | 2.36 | 0.98 |
| | Chemical | | | | | | |
| | Corporation | | | | | | |
| CB-B | Mitsubishi | #3230B | Surface treatment | 23 | 668 | 2.58 | 1.17 |
| | Chemical | | | | | | |
| | Corporation | | | | | | |
| CB-C | Denka Company | Denka Black | Nitrogen treatment | 35 | 776 | 0.23 | 0.21 |
| | Limited | | | | | | |
| CB-D | Denka Company | Denka Black | Surface treatment | 35 | 750 | 0.25 | 0.25 |
| | Limited | | | | | | |
| CB-E | Mitsubishi | #44B | Surface treatment | 24 | 651 | 1.04 | 1.13 |
| | Chemical | | | | | | |
| | Corporation | | | | | | |

### Example 1

### Preparation of Electrophotographic Belt

### Pre-Mixing

PEEK (trade name: 381G, manufactured by Victrex plc) was weighed to be 80.0 mass %, the treated carbon black shown in Table 1 was weighed to have the blending ratios shown in Table 2, and these were mixed using a Henschel mixer (FM-150L/I, manufactured by Nippon Coke & Engineering Co., Ltd.). The operating conditions and processing conditions of the Henschel mixer were as follows: a blade rotational speed of 1500 rpm, a processing amount of 30 kg, a processing time of 5 minutes, and a processing temperature of 50° C.

### Melt-Kneading Step

The mixture obtained by the above-mentioned pre-mixing was placed in a twin-screw mixer (Ikegai, PCM43) and melt-kneaded under the conditions of an extrusion rate of 6 kg/h, a screw rotational speed of 100 rpm, and a barrel control temperature of 360° C. to obtain a resin composition. It should be noted that, during kneading, vacuum degassing was performed through an upstream vent hole to remove vaporized components.

### Melt-Extrusion

The resin composition obtained through the above melting-kneading step was pelletized. Next, the pellets were extrusion-molded using a single-screw extrusion molding machine (manufactured by Plastics Engineering Laboratory Co., Ltd.) equipped with a spiral cylindrical die at a tip portion thereof, under conditions of an extrusion rate of 6 kg/h and a die temperature of 380° C., thereby obtaining an electrophotographic belt having an endless shape and including a base layer of a cylindrical film having a thickness of 60 μm.

### Evaluation of Electrophotographic Belt

After the thus prepared electrophotographic belt was placed for 48 hours under an environment of a temperature of 23° C. and a relative humidity of 50%, various evaluations were carried out.

### Evaluation 1: Calculation of Water Content of Base Layer

A sample was cut out from the base layer of the prepared electrophotographic belt, and a water content of the base layer was measured. In the present Example, the measurement was carried out by using a thermogravimetry apparatus (Q500 manufactured by TA Instruments).

A plurality of samples cut out from the base layer of the electrophotographic belt into dimensions of 4 mm×4 mm were stacked in a platinum sample pan having a capacity of 100 μL such that a total mass became 15 mg±4 mg.

Then, a mass of the sample when the sample was heated from a temperature of 30° C. to 100° C. at a rate of 20° C./min under a nitrogen atmosphere and held at 100° C. for 30 minutes was defined as X1. Thereafter, the sample was cooled from 100° C. to 30° C. at a rate of 20° C./min, and a mass of the sample when the sample was further left for 48 hours in an environment at a temperature of 23° C. and a relative humidity of 50% under the atmosphere was defined as X2.

The water content of the base layer was then calculated using water content of base layer=((X2-X1)/X2)×100. As a result, the water content of the base layer according to the present Example was 0.61 mass %.

### Evaluation 2: Measurement of Crystallization Temperature on Cooling

In a differential scanning calorimetry (DSC) apparatus, the peak temperature, which is detected in the process of lowering the temperature from the molten state, is defined as the crystallization temperature on cooling. The crystallization temperature on cooling is a peak temperature that appears when a sample cut out from the base layer is set in a DSC, heated to 400° C. at 10° C./min, and thereafter cooled to room temperature (25° C.) at 10° C./min.

The measuring apparatus used was a differential scanning calorimeter (DSC Q2000, manufactured by TA Instruments Japan Inc.). It should be noted that samples were cut out at three points from a central part of the base layer in the direction perpendicular to the circumferential direction of the electrophotographic belt, and an arithmetic mean value of the measured values thereof was adopted.

### Evaluation 3: Measurement of Thickness Unevenness

The thickness of the belt was measured using a thickness measuring instrument, a Digimatic Indicator ID-C125B (manufactured by Mitutoyo Corporation).

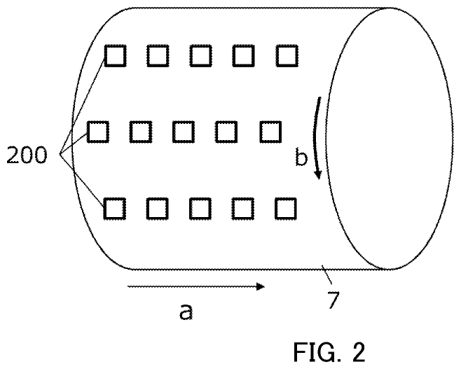

As shown in FIG. 2, thickness measurement locations 200 were set to a total of 40 locations, namely, 5 locations in the a direction in FIG. 2 (the direction perpendicular to the circumferential direction and along the belt 7) and 8 locations evenly spaced in the circumferential direction of the belt 7 (b in the drawing) (8 locations at every 45 degrees when the belt 7 is placed in a circular shape) (note that FIG. 2 shows 15 of the 40 locations for convenience). The standard deviation σ of the thicknesses at the 40 locations was calculated, and the value obtained by dividing σ by an average thickness (σ/average thickness) was used as a thickness unevenness evaluation value. Since molding defects occur when the thickness unevenness evaluation value is 0.100 or more, a value obtained by dividing the standard deviation σ of the thickness by the average thickness (σ/average thickness) is preferably less than 0.080.

### Evaluation 4: Measurement of Surface Resistivity

The electrical resistance value of the electrophotographic belt was measured. The electrical resistance was measured using a Hiresta (manufactured by Mitsubishi Chemical Corporation), by measuring a surface resistivity at a total of 40 points, namely, 5 points in the width direction and 8 points in the circumferential direction, under conditions of an applied voltage of 100 V and after 10 seconds. The surface resistivity of the obtained electrophotographic belt was 5.01×10¹⁰Ω/□.

### Evaluation 5: Evaluation of Images

The prepared electrophotographic belt was mounted as an intermediate transfer belt in an intermediate transfer unit of a copying machine (trade name: “IR-ADVANCE C5051”, manufactured by Canon Inc.), and an image quality test was performed. The printing test was conducted by printing 600,000 full-color images using A4-size paper (manufactured by Canon Inc.; trade name: “GF-600” (basis weight: 60 g/m²)) in an environment at a temperature of 15° C. and a relative humidity of 10%, thereby performing a sheet-passing durability test. After the sheet-passing durability test, 20 sheets of a solid magenta image were output in order to check printed images over the entire circumferential surface of the intermediate transfer belt. The 20 output images were visually inspected to determine whether image density non-uniformity, which is an image defect, occurred, and evaluation was performed based on the following criteria.
Rank “A”: No image defects are observed in any of the printed images.
Rank “B”: Image defects are observed in 1 to 3 printed images.
Rank “C”: Image defects are observed in 4 or more printed images.

In the printed images after the sheet-passing durability test in the present Example, no image defects were observed. Therefore, the image quality evaluation was rated as “A”.

### Decrease in Resistance

Further, after printing 600,000 sheets, the surface resistivity of the electrophotographic belt was measured under the same conditions as those before the sheet-passing durability test. The amount of change in resistance before and after the durability test was calculated from an initial resistance value (an electrical resistance value before the sheet-passing durability test) and an electrical resistance value after the sheet-passing durability test. It should be noted that the difference in orders of magnitude Δ was determined by the following calculation. Here, an initial resistance value is defined as ρ0, and a resistance value after the durability test is defined as ρ.

$$Difference in orders of magnitude Δ = Log ( ρ 0 ) - Log ( ρ ) \qquad ( 3 )$$

The surface resistivity of the electrophotographic belt of Example 1 after the sheet-passing durability test was 4.23×10¹⁰Ω/□, and the amount of change in resistivity before and after the durability test was 0.07 orders of magnitude.

### Examples 2 to 4 and Comparative Examples 1 to 3

Using a material composition and blending ratios described in Table 2, the electrophotographic belts of Examples 2 to 4 and Comparative Examples 1 to 3 were respectively prepared by the same manufacturing method as that of Example 1. Each of the obtained electrophotographic belts was subjected to various evaluations by the same method as that of Example 1.

### Example 2

An electrophotographic belt was prepared in the same manner as in Example 1, except that the type and mixing ratio of the carbon black (CB) were adjusted as shown in Table 2.

### Example 3

An electrophotographic belt was prepared in the same manner as in Example 1, except that the type and the mixing ratio of the carbon black (CB) were adjusted as shown in Table 2 such that the PEEK content was 75.0 mass %.

### Example 4

An electrophotographic belt was prepared in the same manner as in Example 1, except that the type and mixing ratio of the carbon black (CB) were adjusted as shown in Table 2.

### Comparative Example 1

An electrophotographic belt was prepared in the same manner as in Example 1, except that the type and mixing ratio of the carbon black (CB) were adjusted as shown in Table 2.

### Comparative Example 2

An electrophotographic belt was prepared in the same manner as in Example 1, except that the type and mixing ratio of the carbon black (CB) were adjusted as shown in Table 2.

### Comparative Example 3

An electrophotographic belt was prepared in the same manner as in Example 1, except that the type and mixing ratio of the carbon black (CB) were adjusted as shown in Table 2.

In Example 1, the film thickness unevenness and image evaluation after a sheet-passing durability test showed favorable results.

The amount of change in the resistance value before and after the sheet-passing durability test was also small, and it is considered that a change in the resistance value was unlikely to occur even in response to discharges generated in a gap between the inner peripheral surface side of the intermediate transfer member and the primary transfer roller in the primary transfer portion, or in a gap between the outer peripheral surface of the intermediate transfer member and the sheet in the secondary transfer portion. As a result, it is considered that no image defects occurred even after the sheet-passing durability test.

In addition, by adding the second carbon black, the crystallization temperature on cooling increased, and it was possible to suppress film thickness unevenness.

Also in Examples 2 to 4, when the base layer water content was 0.60 mass % or more, images after sheet passing were favorable.

In Example 2, CB-D, which is the second carbon black subjected to surface treatment, had a slightly lower crystallization temperature on cooling than that in Example 1 because a trace amount of functional groups were formed on the surface by the surface treatment. However, film thickness unevenness was able to be suppressed.

In Example 3, although a proportion of the first carbon black increased, the crystallization temperature on cooling increased due to the second carbon black, and film thickness unevenness was able to be suppressed.

In Example 4, although the crystallization temperature on cooling was lower than that of Example 1 due to surface treatment of the first carbon black and the second carbon black, film thickness unevenness was able to be suppressed.

An electrophotographic belt according to Comparative Example 1 contained only the first carbon black, and therefore the crystallization temperature on cooling was low, and film thickness unevenness became large.

It is considered that an electrophotographic belt according to Comparative Example 2 had a low crystallization temperature on cooling because the thermal decomposition temperature of the second carbon black was less than 700° C., and film thickness unevenness became large.

An electrophotographic belt according to Comparative Example 3 had a high thermal decomposition temperature of the first carbon black, and film thickness unevenness was able to be suppressed. However, since the water content of the belt base layer was low, it is considered that image defects occurred due to a decrease in resistance during durability. It is considered that the water content of the base layer of the belt is low because the water absorption rate of the carbon black itself is low.

TABLE 2

| | | | | | | Comparative | Comparative | Comparative |
|---|---|---|---|---|---|---|---|---|
| | | Example | Example | Example | Example | Example | Example | Example |
| | | 1 | 2 | 3 | 4 | 1 | 2 | 3 |
| CB1 type | | CB-A | CB-A | CB-A | CB-B | CB-A | CB-A | CB-C |
| Amount added | mass % | 18.5 | 18.5 | 24.0 | 18.5 | 19.0 | 18.5 | 19.0 |
| CB2 type | | CB-C | CB-D | CB-C | CB-D | — | CB-E | — |
| Amount added | mass % | 0.5 | 0.5 | 0.5 | 0.5 | — | 0.5 | — |
| Water content | mass % | 0.61 | 0.63 | 0.83 | 0.72 | 0.66 | 0.63 | 0.20 |
| of base layer | | | | | | | | |
| Crystallization | ° C. | 297.2 | 296.5 | 296.7 | 295.1 | 289.3 | 290.1 | 300.5 |
| temperature | | | | | | | | |
| on cooling | | | | | | | | |
| σ/average thickness | — | 0.039 | 0.047 | 0.051 | 0.079 | 0.215 | 0.182 | 0.031 |
| Surface resistivity | ×10¹⁰ | 5.01 | 4.95 | 1.43 | 5.22 | 6.15 | 5.59 | 3.12 |
| | Ω/□ | | | | | | | |
| Amount of change | Δ digit | 0.07 | 0.05 | 0.03 | 0.03 | 0.04 | 0.06 | 2.75 |
| in surface resistance | | | | | | | | |
| Image after | Rank | A | A | A | A | A | A | C |
| durability test | Number | 0 | 0 | 0 | 0 | 0 | 0 | 14 |
| | of | | | | | | | |
| | defects | | | | | | | |

As described above, by increasing the water content of the base layer of the electrophotographic belt, a decrease in resistance can be suppressed, and by setting the crystallization temperature on cooling of the base layer to 295.0° C. or higher, film thickness unevenness can be suppressed. Accordingly, it becomes possible to obtain an electrophotographic belt that can achieve both suppression of molding defects and suppression of a decrease in electrical resistance value even through use for a long period of time.

According to at least one aspect of the present disclosure, it is possible to provide an electrophotographic belt capable of both suppressing a decrease in electrical resistance and suppressing molding defects. In addition, according to at least one aspect of the present disclosure, it is possible to provide an image forming apparatus including the electrophotographic belt as an intermediate transfer belt.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An electrophotographic belt, comprising:
at least a base layer, wherein
the base layer comprises polyether ether ketone and carbon black,
a content of the carbon black, based on a mass of the base layer, is 19.0 to 30.0 mass %,
the carbon black comprises
a first carbon black having a thermal decomposition temperature of less than 700° C. and
a second carbon black having a thermal decomposition temperature of at least 700° C.,
in a case where, when a sample cut out from the base layer is heated from 30° C. to 100° C. at a rate of 20° C./min under a nitrogen atmosphere and held at 100° C. for 30 minutes, a mass of the sample is defined as X1, and thereafter, when the sample is cooled from 100° C. to 30° C. at a rate of 20° C./min and further left for 48 hours in an environment at a temperature of 23° C. and a relative humidity of 50% under the atmosphere, a mass of the sample is defined as X2,
a water content of the base layer, which is calculated by water content of base layer=((X2−X1)/X2)×100, is at least 0.60 mass %, and
a crystallization temperature on cooling measured in differential scanning calorimetry of the base layer is at least 295.0° C.

2. The electrophotographic belt according to claim 1, wherein the thermal decomposition temperature of the first carbon black is not higher than 680° C.

3. The electrophotographic belt according to claim 1, wherein the thermal decomposition temperature of the second carbon black is at least 730° C.

4. The electrophotographic belt according to claim 1, wherein a number-average particle diameter of primary particles of the first carbon black is at least 15 nm and less than 35 nm.

5. The electrophotographic belt according to claim 1, wherein a water absorption rate of the first carbon black, as determined by Formula (2) below, is at least 0.70 mass %,
the mass of the first carbon black after being left for 48 hours under conditions of a temperature of 23° C. and a relative humidity of 50% is measured using a thermogravimetric analyzer and is defined as W0, the mass of the first carbon black for which W0 was measured, when the first carbon black is heated from 30° C. to 120° C. at 20° C./min under a nitrogen atmosphere and held at a temperature of 120° C. for 15 minutes, is measured using a thermogravimetric analyzer, and is defined as W1:
$$water absorption rate = [ ( W 0 - W 1 ) / W 0 ] \times 100. \qquad ( 2 )$$

6. The electrophotographic belt according to claim 1, wherein a number-average particle diameter of primary particles of the second carbon black is at least 15 nm and less than 50 nm.

7. The electrophotographic belt according to claim 1, wherein a content of the first carbon black based on a mass of the base layer is at least 18.0 mass %.

8. The electrophotographic belt according to claim 1, wherein a content of the second carbon black based on a mass of the base layer is at least 0.5 mass %.

9. The electrophotographic belt according to claim 1, wherein the base layer is a cylindrical extrusion molded product of a resin composition containing the polyether ether ketone and the carbon black.

10. The electrophotographic belt according to claim 1, wherein a surface resistivity of the base layer is from 1.0×10³Ω/□ to 1.0×10¹⁴Ω/□.

11. The electrophotographic belt according to claim 1, wherein a thickness of the base layer is 25 to 100 μm.

12. The electrophotographic belt according to claim 1, wherein the electrophotographic belt is an intermediate transfer belt.

13. An electrophotographic image forming apparatus comprising:
an electrophotographic belt, comprising
at least a base layer, wherein
the base layer comprises polyether ether ketone and carbon black,
a content of the carbon black, based on a mass of the base layer, is 19.0 to 30.0 mass %,
the carbon black comprises
a first carbon black having a thermal decomposition temperature of less than 700° C. and
a second carbon black having a thermal decomposition temperature of at least 700° C.,
in a case where, when a sample cut out from the base layer is heated from 30° C. to 100° C. at a rate of 20° C./min under a nitrogen atmosphere and held at 100° C. for 30 minutes, a mass of the sample is defined as X1, and thereafter, when the sample is cooled from 100° C. to 30° C. at a rate of 20° C./min and further left for 48 hours in an environment at a temperature of 23° C. and a relative humidity of 50% under the atmosphere, a mass of the sample is defined as X2,
a water content of the base layer, which is calculated by water content of base layer=((X2−X1)/X2)×100, is at least 0.60 mass %, and
a crystallization temperature on cooling measured in differential scanning calorimetry of the base layer is at least 295.0° C.
